(19) United States
(12) Patent Application Publication
(10) Pub. No.: US 2020/0380502 A1
(43) Pub. Date: Dec. 3, 2020

(54) METHOD, SYSTEM, AND DEVICE FOR OBTAINING BANK CARD SIGNING INFORMATION ELEMENT

(71) Applicant: Alibaba Group Holding Limited, George Town (KY)

(72) Inventor: Haijian Jiang, Hangzhou (CN)

(73) Assignee: Alibaba Group Holding Limited, George Town (KY)

(21) Appl. No.: 16/814,824

(22) Filed: Mar. 10, 2020

Related U.S. Application Data
(63) Continuation of application No. PCT/CN2020/070863, filed on Jan. 8, 2020.

(30) Foreign Application Priority Data
May 29, 2019 (CN) 201910455583.X

(51) Int. Cl. G06Q 20/38; G06Q 20/32; G06Q 20/02

(52) U.S. Cl. CPC G06Q 20/3825; G06Q 20/02; G06Q 20/3276; G06Q 20/3223

(57) ABSTRACT

Computer-implemented methods, non-transitory, computer-readable media, and computer-implemented systems for obtaining a bank card signing information element are provided. A bank card signing request is received. The bank card signing request can be obtained only by an application or device authorized by a first user. The bank card signing request is generated by a card issuing bank of a to-be-signed bank card for the to-be-signed bank card. The to-be-signed bank card is a bank card of the first user. The bank card signing request is parsed to obtain a bank card token corresponding to the to-be-signed bank card. An access request to the card issuing bank based on the bank card token is initiated to obtain a signing information element corresponding to the bank card token.

### CROSS-REFERENCE TO RELATED APPLICATIONS

This application is a continuation of PCT Application No. PCT/CN2020/070863, filed on Jan. 8, 2020, which claims priority to Chinese Patent Application No. 201910455583.X, filed on May 29, 2019, and each application is hereby incorporated by reference in its entirety.

### TECHNICAL FIELD

The present application relates to the field of computer technologies, and in particular, to methods, systems, and devices for obtaining a bank card signing information element.

### BACKGROUND

In an electronic payment application scenario, electronic payment operations are usually performed by using a third-party electronic payment institution other than a banking institution. To simplify an electronic payment process of the third-party electronic payment institution, a user of the third-party electronic payment institution can sign his own bank card with the electronic payment institution. After the signing succeeds, the user can directly use the card in a quick payment scenario of the electronic payment institution.

In the existing technology, the process of signing a bank card with a third-party electronic payment institution is usually as follows: A user completes information matching and authentication with the bank and the payment institution through mobile phone short messaging, card holder authentication, etc. and completes the process of binding the bank card to a payment institution account. During the previous bank card signing process, the user needs to manually enter the signing information element, including card holder information (name, identity information, mobile phone number), bank card information (card number, card verification value 2 (CVV2), validity period, and bank identification number (BIN)). Because the information included in the signing information element is complex and inconvenient to memorize, the user can easily enter incorrect signing information element or forget the signing information element, and consequently, the bank card cannot be signed successfully.

### SUMMARY

In view of this, implementations of the present specification provide a method, system, and device for obtaining a bank card signing information element, so that accurate signing information element can be obtained during a process of signing a bank card with a payment institution.

The following technical solutions are used in the implementations of the present specification.

An implementation of the present specification provides a method for obtaining a bank card signing information element, including: obtaining a bank card signing request, where the bank card signing request can be obtained only by an application or device authorized by a first user, the bank card signing request is generated by a card issuing bank of a to-be-signed bank card for the to-be-signed bank card, and the to-be-signed bank card is a bank card of the first user; parsing the bank card signing request to obtain a bank card token corresponding to the to-be-signed bank card; and initiating an access request to the card issuing bank based on the bank card token, to obtain a signing information element corresponding to the bank card token.

In an implementation of the present specification, obtaining a bank card signing request includes: receiving the bank card signing request, where the bank card signing request is output based on an operation of the first user at an invocation end of a bank application; and/or, collecting the bank card signing request, where the bank card signing request is collected by a code scanning operation of the first user on a bank counter.

In an implementation of the present specification, the method further includes: invoking and entering an application for parsing the bank card signing request based on the bank card signing request.

In an implementation of the present specification, invoking and entering an application for parsing the bank card signing request based on the bank card signing request includes: invoking the application based on a summary with a landing page, where the summary specifies an application opening link with a fixed application identifier.

In an implementation of the present specification, an application of a payment institution that requires bank card signing is used to parse the bank card signing request, initiate the access request to the card issuing bank, and obtain the signing information element.

In an implementation of the present specification, an application that a user has successfully logged in to is used obtain the bank card signing request, parse the bank card signing request, initiate the access request to the card issuing bank, and obtain the signing information element.

An implementation of the present specification further provides a method for generating a bank card signing request, including: verifying an identity of a first user, and verifying a to-be-signed bank card of the first user based on the identity of the first user; generating a bank card token corresponding to the to-be-signed bank card; and generating a bank card signing request based on the bank card token.

In an implementation of the present specification, a bank card signing request for a new card is generated when a card issuing bank issues a card for the first user.

An implementation of the present specification further provides a method for signing a bank card, including: obtaining a signing information element of the to-be-signed bank card corresponding to a first user by using the method according to the implementation of the present specification; and signing the to-be-signed bank card for a payment institution account of the first user based on the signing information element.

In an implementation of the present specification, signing the to-be-signed bank card for a payment institution account of the first user based on the signing information element includes: verifying whether the signing information element matches the first user; and when the signing information element matches the first user, entering automatic signing process.

In an implementation of the present specification, verifying whether the signing information element matches the first user includes: checking whether information stored in the payment institution by the first user is consistent with the signing information element; and when the information stored in the payment institution by the first user is consistent with the signing information element, displaying desensitized information of the signing information element to the first user, to request the first user to verify whether the desensitized information is consistent with information reserved in the card issuing bank by the first user.

An implementation of the present specification further provides a bank card signing information element acquisition system, including: a bank card signing request receiving module, configured to obtain a bank card signing request after being authorized by a first user, where the bank card signing request is generated by a card issuing bank of a to-be-signed bank card for the to-be-signed bank card, and the to-be-signed bank card is a bank card of the first user; a bank card signing request parsing module, configured to parse the bank card signing request to obtain a bank card token corresponding to the to-be-signed bank card; and a bank access module, configured to obtain, based on the bank card token, a signing information element of the to-be-signed bank card from the card issuing bank.

An implementation of the present specification further provides a system for generating a bank card signing request, including: an identity verification module, configured to verify an identity of a first user, and verify a to-be-signed bank card of the first user based on the identity of the first user; a token generation module, configured to generate a bank card token corresponding to the to-be-signed bank card; and a bank card signing request generation module, configured to generate a bank card signing request based on the bank card token.

An implementation of the present specification further provides a bank card signing system, including: a signing information element acquisition module, configured to receive signing information element from the bank card signing information element acquisition system according to the implementations of the present specification; and a signing module, configured to sign a to-be-signed bank card for a payment institution account of a first user based on the signing information element.

An implementation of the present specification further provides a device for processing information at an access device end, including: a memory, configured to store computer program instructions, and a processor, configured to execute the computer program instructions, where when the computer program instructions are executed by the processor, the device is triggered to perform the method according to the implementations of the present specification.

The at least one technical solution used in the implementation of the present specification can achieve the following beneficial effects: According to the method in the implementations of the present specification, the signing information element of the to-be-signed bank card can be obtained from the card issuing bank, thereby alleviating the occurrence of manual input error caused when the user manually enters the signing information element or forgets the signing information element. Compared with the existing technology, the method in the implementations of the present specification can ensure the accuracy of the signing information element, thereby improving a success rate of signing a bank card.

### BRIEF DESCRIPTION OF DRAWINGS

The accompanying drawings described here are intended to provide a further understanding of the present application and constitute a part of the present application. The example implementations of the present application and the descriptions thereof are intended to explain the present application and do not constitute an undue limitation on the present application. In the accompanying drawings:

FIG. 1 to FIG. 4 and FIG. 6 are flowcharts illustrating operating methods of applications, according to implementations of the present specification;

FIG. 5 is a flowchart illustrating an automatic signing process of an application, according to an implementation of the present specification; and

FIG. 7 to FIG. 9 are structural block diagrams illustrating systems, according to implementations of the present specification.

### DESCRIPTION OF IMPLEMENTATIONS

To make the objectives, technical solutions, and advantages of the present application clearer, the following clearly and comprehensively describes the technical solutions of the present application with reference to specific implementations of the present application and corresponding accompanying drawings. Clearly, the described implementations are only some rather than all of the implementations of the present application. All other implementations obtained by a person of ordinary skill in the art based on the implementations of the present application without creative efforts shall fall within the protection scope of the present application.

In the existing technology, when signing a bank card with a payment institution, a user needs to manually enter signing information element. Because the information included in the signing information element is complex and inconvenient to memorize, the user may easily enter incorrect signing information element or forget the signing information element, and consequently, the bank card cannot be signed successfully. To alleviate the previous problem, an implementation of the present specification provides a method for obtaining the information of the signing elements of a bank card. To provide the methods of the implementation of the present specification, the inventor first analyzes an actual bank card signing application scenario.

To alleviate the influence caused when the user enters incorrect signing information element or forgets the signing information element, the most straightforward solution is to cancel the manual input operation, and obtain the signing information element directly from the data source of the signing information element. Further, the signing information element is private information of a bank card user, and is related to the bank account security of the bank card user. Therefore, to prevent the signing information element from being disclosed or tampered with, the signing information element needs to be stored in a system of the card issuing bank rather than a third-party system. As such, the signing information element can be obtained only after the data system of the card issuing bank is accessed. Therefore, in an implementation of the present specification, the signing information element is directly obtained from the card issuing bank.

Further, to prevent the signing information element from being disclosed or tampered with, the card issuing bank needs to ensure that the signing information element can be obtained only by an authorized user corresponding to the signing information element (in the bank card signing application scenario, the card issuing bank needs to ensure that the signing information element can be accessed by a system bound to the owner of the to-be-signed bank card). Therefore, in an implementation of the present specification, when accessing a card issuing bank to obtain the signing information element, an authentication request needs to be initiated to the card issuing bank, so that the card issuing bank performs authentication and returns the signing information element that matches the identity of the access user.

Further, because the user who needs the signing information element needs to be bound to the payment institution of the bank card, for the previously described technical solution, a relatively simple implementation is as follows: The payment institution initiates an authentication request to the user of the specified payment institution to the card issuing bank; the card issuing bank verifies the corresponding bank card owner based on the received authentication request; and finally the card issuing bank returns the corresponding signing information element to the payment institution. The prerequisites for the implementation of the previous solution include:

1. The issuing bank can identify and verify the authentication request sent by the payer.

2. The issuing bank can verify the only corresponding bank card owner correctly based on the authentication request. This requires not only the unique correspondence between the identity data information included in the authentication request and the real identity of the user, but also the matching of the identity data information stored in the payment institution and the data system of the card issuing bank.

However, because the payment institution generally does not strictly require the user to input complete user information, and does not strictly verify the user information, some user accounts may not include the identity data information used to generate the authentication request, or the user information in some user accounts does not uniquely match the correct user.

For example, for an application solution in which real-name information (for example, identity certificate type+certificate number) is used as identity data information, although it can be ensured that real-name information can match a unique corresponding bank card owner at the card issuing bank, but in the payment institution, not all users are authenticated with the real-name information, or the real-name information is not stored. For another example, for the application solution in which a mobile phone number is used as identity data information, if a mobile phone of a user is not bound to a payment institution, signing of the bank card of the user will fail; in addition, the authenticity of a mobile phone number may not be ensured, and some unauthenticated mobile phone numbers will degrade the security of authentication at the card issuing bank.

In summary, in a practical application scenario, general applicability of initiating user authentication to the card issuing bank based on user information stored by the payment institution cannot be ensured. Therefore, in an implementation of the present specification, the payment institution does not initiate user authentication to the card issuing bank, but the user initiates user authentication to the card issuing bank. After the card issuing bank successfully authenticates the user, the signing information element corresponding to the user is output.

Further, in an implementation of the present specification, a receiver of the signing information element can only be an authorized executor or an authorized associate of a current bank card signing operation, that is, a related application that is authorized to perform the current bank card signing operation. In other words, the receiver of the signing information element can only be a device/application authorized by the user. For example, the receiver of the signing information element is an authorized application installed on the device that is operated by the user performing the current bank card signing operation. The authorized application collects/receives the signing information element under the operation of the user, which is equivalent to that the user authorizes to collect/receive the operation. Alternatively, further, the receiver of the signing information element is an application to which the user has successfully logged in. When the application collects/receives signing information element based on a setting of the user, the execution entity is an account of the user, and the operation performed based on the account of the user is verified by the user, which is equivalent to that the user authorizes to collect/receive the signing information element.

Further, to alleviate interception or incorrect output of the signing information element in the output process, token-based access is used in this implementation of the present specification. Specifically, the card issuing bank sends an access token corresponding to the signing information element to the device/application corresponding to the user, and the device/application corresponding to the user obtains the signing information element from the card issuing bank by using the access token after obtaining the access token.

According to the method in the implementations of the present specification, the signing information element of the to-be-signed bank card can be obtained from the card issuing bank, thereby alleviating the occurrence of manual input error caused when the user manually enters the signing information element or forgets the signing information element. Compared with the existing technology, the method in the implementations of the present specification can ensure the accuracy of the signing information element, thereby improving a success rate of signing a bank card.

The following describes in detail the implementations of the present specification.

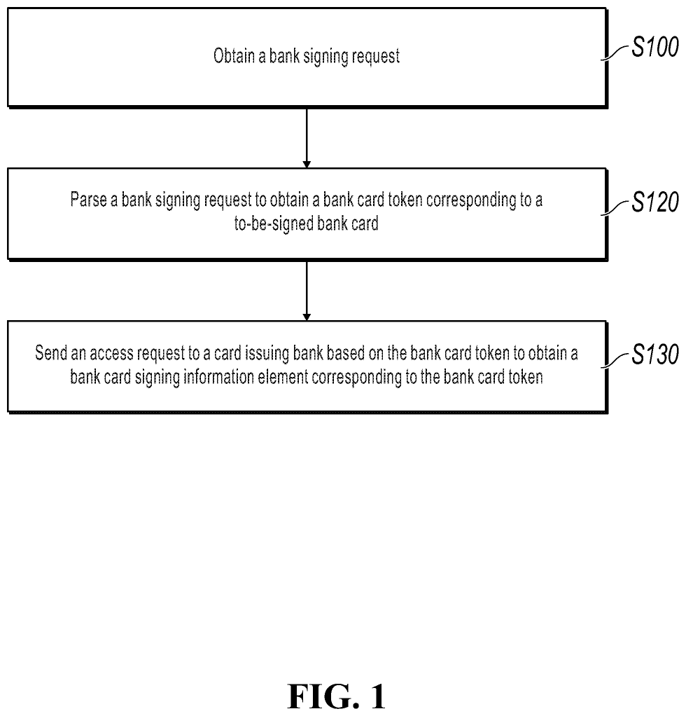

An implementation of the present specification provides a method for obtaining a bank card signing information element. As shown in FIG. 1, the method includes the following steps:

S110: Obtain a bank card signing request, where the bank card signing request can be obtained only by an application or device authorized by a first user, the bank card signing request is generated by a card issuing bank of a to-be-signed bank card for the to-be-signed bank card, and the to-be-signed bank card is a bank card of the first user.

S120: Parse the bank card signing request to obtain a bank card token corresponding to the to-be-signed bank card.

S130: Initiate an access request to the card issuing bank based on the bank card token to obtain a signing information element corresponding to the bank card token.

Specifically, in an implementation of the present specification, the bank card token corresponds to a unique to-be-signed bank card. Specifically, in an implementation of the present specification, the bank card signing request is parsed to obtain a card issuing institution, a bank card type, and an identifier of a unique bank card token.

Further, in an implementation of the present specification, in a process of obtaining the signing information element corresponding to the bank card token, to ensure data security, the signing information element corresponding to the bank card token is obtained from the card issuing bank based on the bank card token through a dedicated line.

Further, in a practical application scenario, the signing information element may not be stored uniformly in the card issuing bank as the signaling information element. Therefore, in an implementation of the present specification, an access request is initiated to the card issuing bank based on the bank card token, to request the card issuing bank to return the signing information element of the current bank. After verifying the access request, the card issuing bank invokes the information element used for bank card signing from information saved by the bank card account and outputs the information element.

Specifically, in an implementation of the present specification, in step S110, an application or device authorized by the first user obtains the bank card signing request. Specifically, in an application scenario, an authorized application installed on a device (such as a mobile phone) that the user currently operates obtains the bank card signing request. The user operates the application to obtain the bank card signing request. Further, in an implementation of the present specification, the executor of step S120 and step S130 is also an application or device authorized by the first user. Specifically, in an implementation of the present specification, the executor of steps S110 to S130 is the same application authorized by the first user.

Further, in an implementation of the present specification, the bank card signing request is actively collected in the process of obtaining the bank card signing request. Specifically, in an implementation of the present specification, the bank card signing request is collected in the process of obtaining the bank card signing request, where the bank card signing request is collected through a code scanning operation performed by a first user on a bank counter.

Further, in an implementation of the present specification, the bank card signing request is passively received in the process of obtaining the bank card signing request. Specifically, in an implementation of the present specification, the bank card signing request is received in the process of obtaining a bank card signing request, where the bank card signing request is output based on an operation performed by the first user at an invocation end of a bank application.

Further, in an implementation of the present specification, a same application is used to obtain the bank card signing request, parse the bank card signing request, initiate an access request to the card issuing bank, and obtain the signing information element.

Further, the application that processes the bank card signing request is not always in an on/started state. Therefore, in an implementation of the present specification, the method further includes invoking and entering an application for parsing a bank card signing request based on a bank card signing request.

Specifically, in an implementation of the present specification, the bank card signing request is obtained (accepted or collected) by a third-party application that has been authorized by a user (for example, an operating system of a mobile device), and then an application for parsing the bank card signing request is invoked, based on the bank card signing request, by the third-party application that has obtained the bank card signing request.

Specifically, in an implementation of the present specification, the first user invokes and enters a corresponding application by performing a code scanning operation at an invocation end of the bank application or on a bank counter.

Specifically, in an implementation of the present specification, application (App) invocation is performed by using a schema with a landing page, where the schema specifies application opening link with a fixed application identifier.

Specifically, in an implementation of the present specification, in an application scenario:

Landing page URL:https://render.XXX.com/p/s/i/?schema=′ “schema” specifies an application opening link with a fixed AppId (20000067): alipays://platformapi/startapp?appId=20000067&url=

Further, as the current user may not be the only user of the current device and/or application, in an implementation of the present specification, an application to which the user has successfully logged in is used to obtain the bank card signing request, parse the bank card signing request, initiate an access request to the card issuing bank, and obtain the signing information element.

Specifically, in an application scenario, after successfully logging in to an authorized application installed on a device (for example, a mobile phone) that the user is currently operating, the user operates the application to obtain the bank card signing request.

Further, considering that the receiver of the final signing information element is a payment institution in the bank card signing process, in an implementation of the present specification, an application of the payment institution (a payment institution App) that requires bank card signing is used to obtain the bank card signing request, parse the bank card signing request, initiate an access request to the card issuing bank, and obtain the signing information element.

Further, considering that the application of the payment institution is not always in an on/started state, in an implementation of the present specification, a bank card signing request is obtained (accepted or collected) by a third-party application authorized by the user (for example, an operating system of a mobile device), and then the third-party application that has obtained the bank card signing request invokes, based on the bank card signing request, the application of the payment institution that requires bank card signing, and then the application of the payment institution parses the bank signing request, initiates an access request to the bank card, and obtains the signing information element.

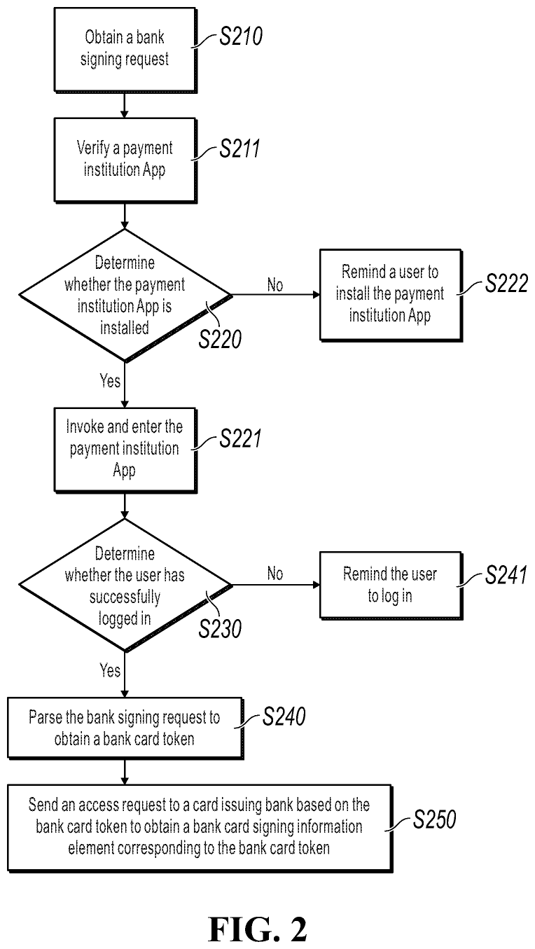

Specifically, as shown in FIG. 2, in an implementation, the method includes the following steps.

S210: Perform code scanning at an invocation end of a bank App or on a bank counter, to obtain a bank card signing request.

S211: Verify the payment institution App corresponding to the bank card signing request.

S220: Determine whether the payment institution App is installed.

S221: Invoke and enter the payment institution App (when it is determined in step S220 that the payment institution App is installed).

S222: Remind the user to install the payment institution App (when it is determined in step S220 that the payment institution App is not installed).

S230: The payment institution App obtains the user login status and determines whether the user has successfully logged in.

S240: Parse the bank card signing request to obtain a bank card token (when it is determined in S230 that the user has successfully logged in).

S241: Remind the user to log in (when it is determined in S230 that the user has not logged in).

S250: Initiate an access request to the card issuing bank based on the bank card token to obtain a signing information element corresponding to the bank card token.

Further, in an implementation of the present specification, a dedicated line is used for the data communication with the card issuing bank (in an actual application scenario, a specific link format of the dedicated line is determined by the card issuing bank).

Further, in an implementation of the present specification, the interface for obtaining the signing information element is a back-end interface provided by the card issuing bank; the XML format is used by the interface for exchanging a request/response message with the card issuing bank; an HTTP request is used for exchanging information with the card issuing bank; a digital signature is added for an entire packet, the signing algorithm is SHA256withRSA, and the encryption is based on Base64; and no encryption is performed for packet transmission.

Specifically, in an implementation, the format of the bank card signing request is shown in Table 1.

TABLE 1

| | | | Appearance |
|---|---|---|---|
| Name | Field | Type | requirement |
| Institution identifier | instld | string | M |
| Transaction time | date | string | M |
| Bank card token | token | string | M |
| Message extension | extensions | Custom | O |

In Table 1, the institution identifier, trading time, and bank card token are mandatory, that is, the appearance requirement is Must (M); and the message extension is optional, that is, the appearance requirement is Optional (O).

Specifically, in an implementation of the present specification, the institution identifier of the bank card signing request is the institution identifier of the sender.

Specifically, in an implementation of the present specification, the transaction time of the bank card signing request is the sending time of the bank card signing request. The format is “YYYYMMDD HH:MM:SS”.

Specifically, in an implementation of the present specification, the bank card token is used as an input parameter of the invocation end URL of the bank card signing request. Further, in an implementation of the present specification, the bank card token has a validity period. For example, in an application scenario, a bank card token is valid within 15 minutes after being generated.

Specifically, in an implementation of the present specification, the message extension of the bank card signing request is an institution-specific field. For example, in an application scenario, the message extensions of a bank card signing request include information extension fields such as card equity identification, IP address, and device number Specifically, in an application scenario, the structure of the message extension structure of the bank card signing request is as follows:

<extensions>
<extension>
<name>...</name>
<value>...</name>
<extensions>

Specifically, in an implementation, the format of the signing information element returned by the card issuing bank is shown in Table 2.

TABLE 2

| | | | Appearance |
|---|---|---|---|
| Field | Name | Type | requirement |
| Institution identifier | instld | string | M |
| Transaction time | date | string | M |
| Card number | cardNo | string | M |
| User name | userName | string | M |
| Certificate type | certType | string | M |
| Certificate number | certNo | string | M |
| Mobile phone number | mobile | string | M |
| Return code information | resplnfo | | M |

In Table 2, each item is required, that is, the occurrence requirement is Must (M).

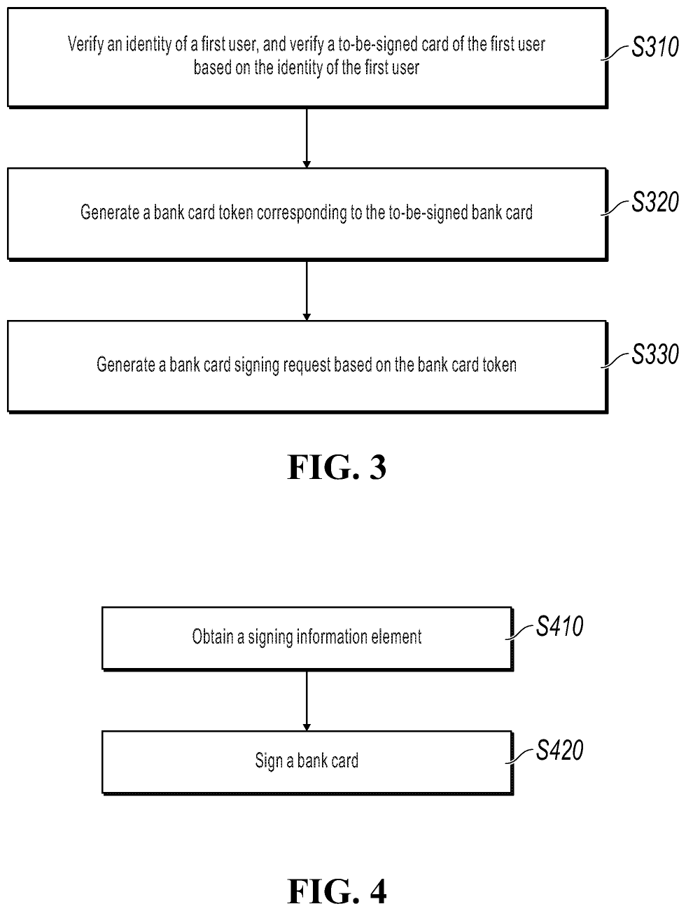

Further, corresponding to the method for obtaining a bank card signing information element provided in the implementations of the present specification, an implementation of the present specification further provides a method for generating a bank card signing request. Specifically, as shown in FIG. 3, in an implementation of the present specification, the method for generating a bank card signing request includes the following steps:

S310: Verify an identity of a first user, and verify a to-be-signed card of the first user based on the identity of the first user.

S320: Generate a bank card token corresponding to the to-be-signed bank card.

S330: Generate a bank card signing request based on the bank card token.

Specifically, in an implementation of the present specification, a bank card signing request for a new card is generated when the card issuing bank issues a bank card for the first user. In the card issuing phase, the identity of the first user is bound when the new card is issued. Therefore, for the new card, the identity of the first user does not need to be verified again. When the new card is issued, only the corresponding bank card signing request for the new card needs to be generated, and then the bank card signing request needs to be sent to the application authorized by the owner of the new card (the first user).

Specifically, in an application scenario, after the user has successfully issued a bank card with a bank, the bank generates a bank card signing request two-dimensional code for the new card, and the user scans the two-dimensional code by using his own device (mobile phone), invokes the application of the payment institution that is installed the device of the user, and obtains the bank card signing request.

Further, based on the method for obtaining a bank card signing information element provided in the implementations of the present specification, an implementation of the present specification further provides a method for signing a bank card. Specifically, as shown in FIG. 4, in an implementation of the present specification, the bank card signing method includes the following steps:

S410: Obtain a signing information element by using the method for obtaining a bank card signing information element described in the implementations of the present specification.

S420: Sign a bank card for a payment institution account of a first user based on the obtained signing information element.

To further ensure that the user corresponding to the signing information element is consistent with the current user of the payment institution, in an implementation of the present specification, a process of signing a bank card for the payment institution account based on the signing information element for the first user includes: determining whether the signing information element matches the first user; and entering an automatic signing process when the signing information element matches the first user.

Specifically, in an implementation of the present specification, a signing process predetermined by the payment institution and the card issuing bank is used as the automatic signing process.

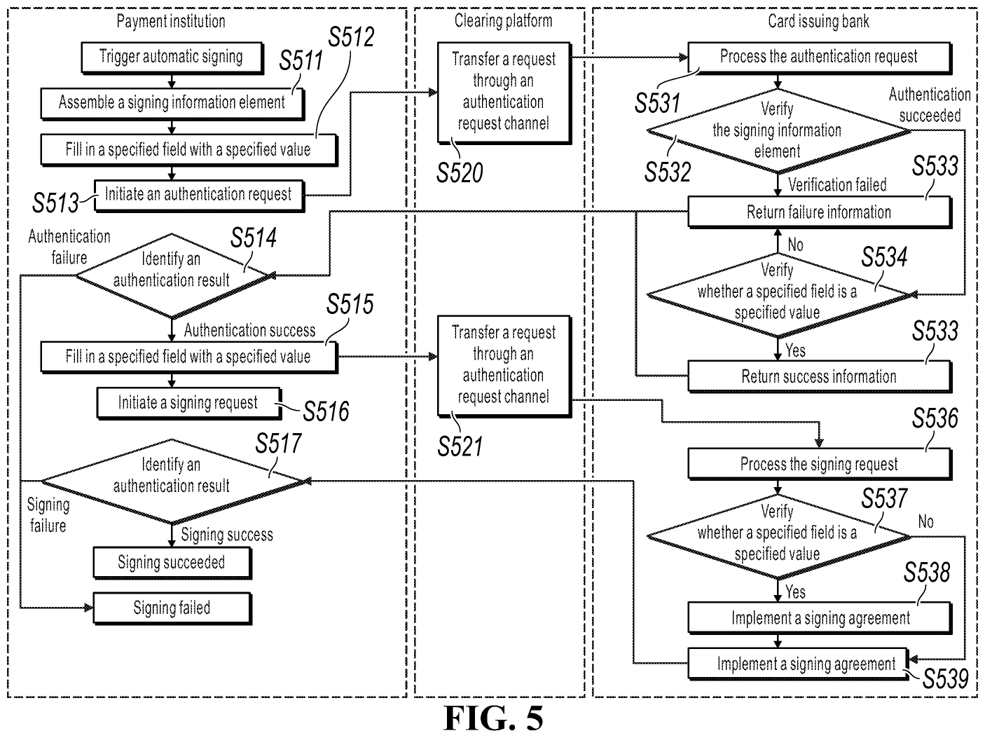

Specifically, in an implementation of the present specification, the automatic signing process is shown in FIG. 5.

After a payment institution triggers the automatic signing process, signing information element is assembled (S511); a specified field (specifically, the “authmsg” field in an application scenario) is filled with a specified value (S512); and an authentication request is initiated (S513).

A clearing platform forwards the authentication request to the card issuing bank through an authentication request channel (S520).

A card issuing bank receives and processes the authentication request (S531); the signing information element is verified (S532); when the signing information element fails to be verified, failure information is returned (S533); when the signing information element is verified successfully, it is verified whether a specified field is a specified value (S534); when the specified field is not the specified value, failure information is returned (S533); and when the specified field is the specified value, success information is returned (S535).

The payment institution receives the failure/success information returned by the card issuing bank and identifies the authentication result (S514); when the authentication fails, the signing fails; and when the authentication succeeds, the specified field is filled with the specified value (S515), and a signing request is initiated (S516).

The clearing platform forwards the signing request to the card issuing bank through the signing request channel (S521).

The issuing bank receives and processes the signing request (S536); it is verified whether the specified field is a specified value (S537); when the specified field is not the specified value, a signing result (signing failure) is returned (S539); and when the specified field is the specified value, implement the signing agreement (S538), and a signing result (signing success) is returned (S539).

The payment institution receives the signing result returned by the card issuing bank and identifies the signing result (S517); when the signing result is a signing failure, the signing fails; or when the signing result is a signing success, the signing succeeds.

Specifically, in an implementation of the present specification, a process of determining whether the signing information element matches the first user includes: checking whether information stored in the payment institution by the first user is consistent with the signing information element; and when the information stored in the payment institution by the first user is consistent with the signing information element, displaying desensitized information of the signing information element to the first user, to request the first user to verify whether the desensitized information is consistent with information reserved in the card issuing bank by the first user.

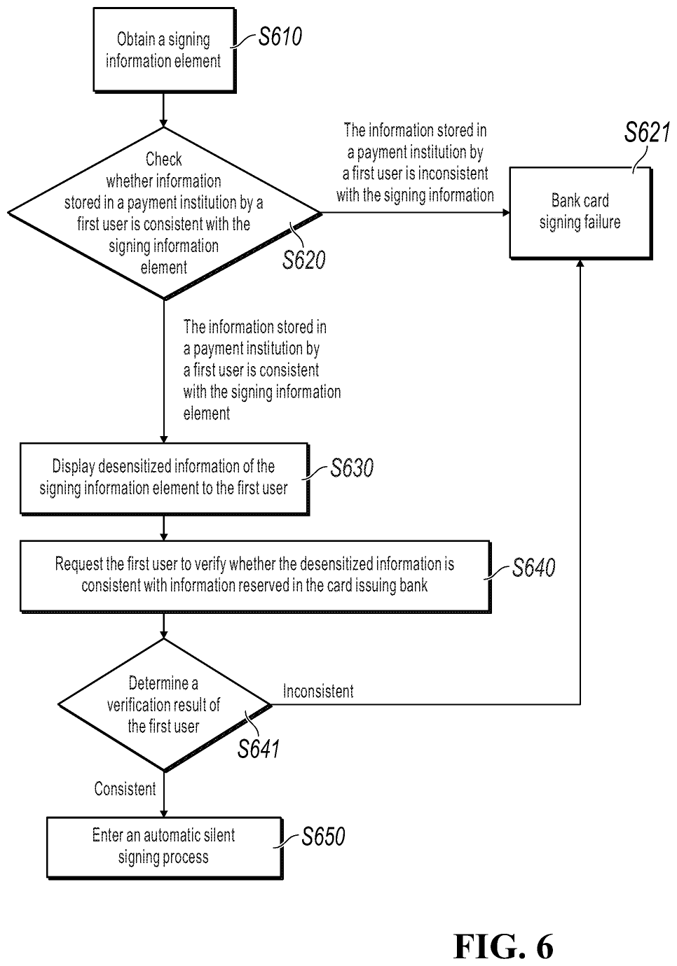

Specifically, in an implementation of the present specification, as shown in FIG. 6, a bank card signing process includes the following steps:

S610: Obtain a signing information element.

S620: Check whether information stored in the payment institution by the first user is consistent with the signing information element.

S621: The bank card signing fails (when the information stored in the payment institution by the first user is inconsistent with the signing information element).

S630: Display desensitized information of the signing information element to the first user (when the information stored in the payment institution by the first user is consistent with the signing information element).

S640: Request the first user to verify whether the desensitized information is consistent with information reserved in the card issuing bank by the first user.

S641: Determine a verification result of the first user.

S650: Enter an automatic signing process (when the desensitized information is consistent with information reserved in the card issuing bank by the first use).

S621: The bank card signing fails (when the desensitized information is inconsistent with information reserved in the card issuing bank by the first use).

Further, in an implementation of the present specification, in the automatic signing process, the payment institution inputs a specific automatic signing identifier and sends, through a network payment clearing platform of a non-bank payment institution between a third-party payment institution, the bank the identifier to the card issuing bank for verification.

Specifically, in an application scenario, the H5 landing page link used by an application of the payment institution to perform bank card signing is:

https://XXX.com/mobile/sign/express/entrance?
instId=XXX&token=&cardType=XX&bankUrl=XXXXXXX

Further, in an implementation of the present specification, the card issuing bank provides a return URL. After the bank card is signed successfully or fails, the user chooses whether to return to the App of the card issuing bank.

Specifically, in an application scenario, the return URL is:

http://XXX.com/mobile/sign/express/entrance?instId=CMB&token=ddf6b4101bba4b98a7f37 0702f9bb5f6&cardType=CC&bankUrl=cmblife %3a%2f%2fcfp.cmb.com

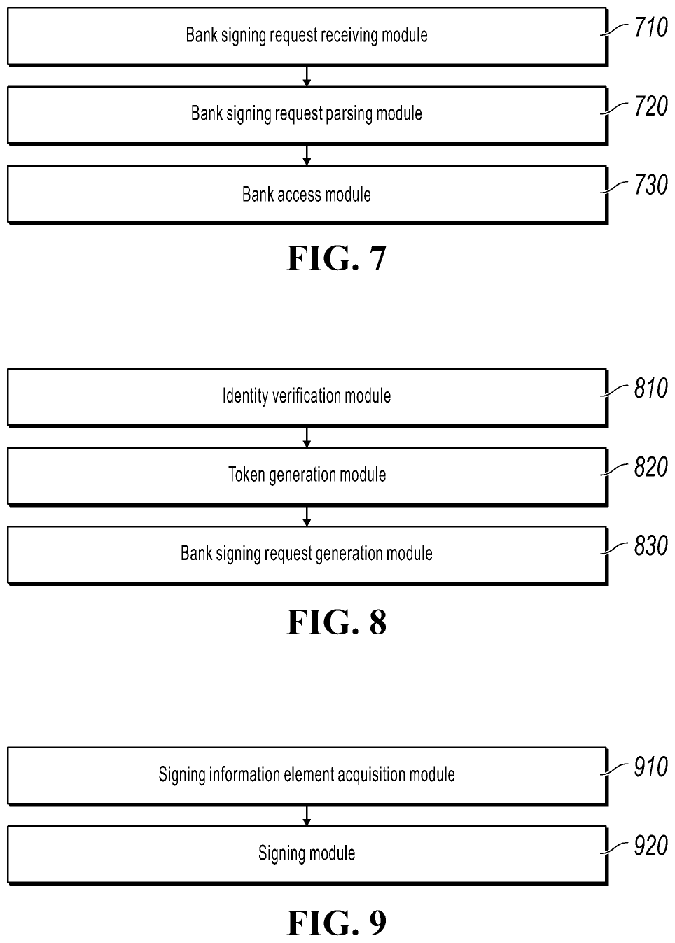

Further, based on the method for obtaining a bank card signing information element in the implementations of the present specification, an implementation of the present specification further provides a bank card signing information element acquisition system. Specifically, as shown in FIG. 7, in an implementation of the present specification, the bank card signing information element acquisition system includes: a bank card signing request receiving module 710, configured to obtain a bank card signing request after being authorized by a first user, where the bank card signing request is generated by a card issuing bank of a to-be-signed bank card for the to-be-signed bank card, and the to-be-signed bank card is a bank card of the first user; a bank card signing request parsing module 720, configured to parse the bank card signing request to obtain a bank card token corresponding to the to-be-signed bank card; and a bank access module 730, configured to obtain, based on the bank card token, a signing information element of the to-be-signed bank card from the card issuing bank.

Further, based on the method for generating a bank card signing request in the implementations of the present specification, an implementation of the present specification further provides a system for generating a bank card signing request. Specifically, as shown in FIG. 8, in an implementation of the present specification, the system for generating a bank card signing request includes: an identity verification module 810, configured to verify an identity of a first user, and verify a to-be-signed bank card of the first user based on the identity of the first user; a token generation module 820, configured to generate a bank card token corresponding to the to-be-signed bank card; and a bank card signing request generation module 830, configured to generate a bank card signing request based on the bank card token.

Further, based on the bank card signing method of the implementations of the present specification, an implementation of the present specification further provides a bank card signing system. Specifically, as shown in FIG. 9, in an implementation of the present specification, the bank card signing system includes: a signing information element acquisition module 910, configured to receive signing information element from the bank card signing information element acquisition system according the implementations of the present specification; and a signing module 920, configured to sign a to-be-signed bank card for a payment institution account of a first user based on the signing information element.

Further, based on the methods of the present specification, an implementation of the present specification further provides a device for processing information at an access device end, including: a memory, configured to store computer program instructions, and a processor, configured to execute the computer program instructions, where when the computer program instructions are executed by the processor, the device is triggered to perform the method according to the present specification.

In the 1990s, whether technology improvement is hardware improvement (for example, improvement of a circuit structure, such as a diode, a transistor, or a switch) or software improvement (improvement of a method procedure) can be obviously distinguished. However, as technologies develop, the current improvement for many method procedures can be considered as a direct improvement of a hardware circuit structure. A designer usually programs an improved method procedure to a hardware circuit, to obtain a corresponding hardware circuit structure. Therefore, a method procedure can be improved by using a hardware entity module. For example, a programmable logic device (PLD) (for example, a field programmable gate array (FPGA)) is such an integrated circuit, and a logical function of the programmable logic device is determined by a user through device programming. The designer performs programming to “integrate” a digital system to a PLD without requesting a chip manufacturer to design and produce an application-specific integrated circuit chip. In addition, at present, instead of manually manufacturing an integrated chip, this type of programming is mostly implemented by using “logic compiler” software. The programming is similar to a software compiler used to develop and write a program. Original code needs to be written in a particular programming language for compilation. The language is referred to as a hardware description language (HDL). There are many HDLs, such as the Advanced Boolean Expression Language (ABEL), the Altera Hardware Description Language (AHDL), Confluence, the Cornell University Programming Language (CUPL), HDCal, the Java Hardware Description Language (JHDL), Lava, Lola, MyHDL, PALASM, and the Ruby Hardware Description Language (RHDL). The very-high-speed integrated circuit hardware description language (VHDL) and Verilog are most commonly used. A person skilled in the art should also understand that a hardware circuit that implements a logical method procedure can be readily obtained once the method procedure is logically programmed by using the several described hardware description languages and is programmed into an integrated circuit.

A controller can be implemented by using any appropriate method. For example, the controller can be a microprocessor or a processor, or a computer-readable medium that stores computer readable program code (such as software or firmware) that can be executed by the microprocessor or the processor, a logic gate, a switch, an application-specific integrated circuit (ASIC), a programmable logic controller, or a built-in microprocessor. Examples of the controller include but are not limited to the following microprocessors: ARC 625D, Atmel AT91SAM, Microchip PIC18F26K20, and Silicone Labs C8051F320. The memory controller can also be implemented as a part of the control logic of the memory. A person skilled in the art also knows that, in addition to implementing the controller by using the computer readable program code, logic programming can be performed on method steps to allow the controller to implement the same function in forms of the logic gate, the switch, the application-specific integrated circuit, the programmable logic controller, and the built-in microcontroller. Therefore, the controller can be considered as a hardware component, and a device configured to implement various functions in the controller can also be considered as a structure in the hardware component. Alternatively, the device configured to implement various functions can even be considered as both a software module implementing the method and a structure in the hardware component.

The system, device, module, or unit illustrated in the previous implementations can be implemented by using a computer chip or an entity, or can be implemented by using a product having a certain function. A typical implementation device is a computer. A specific form of the computer can be a personal computer, a laptop computer, a cellular phone, a camera phone, an intelligent phone, a personal digital assistant, a media player, a navigation device, an email transceiver device, a game console, a tablet computer, a wearable device, or any combination thereof.

For convenience of description, the above devices are described separately in terms of their functions. Certainly, functions of the units may be implemented in the same or different software and/or hardware when the present specification is implemented.

A person skilled in the art should understand that the implementations of the present specification may be provided as methods, systems, or computer program products. Therefore, the present specification can take a form of complete hardware implementations, complete software implementations, or implementations combining software and hardware. Further, the present specification can take a form of a computer program product implemented on one or more computer-usable storage media (including but not limited to disk storage, CD-ROM, and optical storage) containing computer-usable program code.

The present specification is described with reference to the flowcharts and/or block diagrams of the method, the device (system), and the computer program product according to the implementations of the present specification. It is worthwhile to note that computer program instructions can be used to implement each process and/or each block in the flowcharts and/or the block diagrams and a combination of a process and/or a block in the flowcharts and/or the block diagrams. These computer program instructions can be provided for a general-purpose computer, a dedicated computer, an embedded processor, or a processor of another programmable data processing device to generate a machine, so the instructions executed by the computer or the processor of the another programmable data processing device generate a device for implementing a specific function in one or more processes in the flowcharts and/or in one or more blocks in the block diagrams.

These computer program instructions can be stored in a computer readable memory that can instruct the computer or the another programmable data processing device to work in a specific manner, so the instructions stored in the computer readable memory generate an artifact that includes an instruction device. The instruction device implements a specific function in one or more processes in the flowcharts and/or in one or more blocks in the block diagrams.

These computer program instructions can be loaded onto the computer or another programmable data processing device, so a series of operations and steps are performed on the computer or the another programmable device, thereby generating computer-implemented processing. Therefore, the instructions executed on the computer or another programmable device provide steps for implementing a specific function in one or more processes in the flowcharts and/or in one or more blocks in the block diagrams.

In a typical configuration, a computing device includes one or more processors (CPUs), one or more input/output interfaces, one or more network interfaces, and one or more memories.

The memory can include a non-persistent memory, a random access memory (RAM), a non-volatile memory, and/or another form that are in a computer readable medium, for example, a read-only memory (ROM) or a flash memory (flash RAM). The memory is an example of the computer readable medium.

The computer readable medium includes persistent, non-persistent, movable, and unmovable media that can store information by using any method or technology. The information can be a computer readable instruction, a data structure, a program module, or other data. Examples of the computer storage medium include but are not limited to a phase change random access memory (PRAM), a static random access memory (SRAM), a dynamic random access memory (DRAM), another type of RAM, a ROM, an electrically erasable programmable read-only memory (EEPROM), a flash memory or another memory technology, a compact disc read-only memory (CD-ROM), a digital versatile disc (DVD) or another optical storage, a cassette magnetic tape, a magnetic tape/magnetic disk storage, another magnetic storage device, or any other non-transmission medium. The computer storage medium can be used to store information accessible by a computing device. Based on the definition in the present specification, the computer readable medium does not include transitory media such as a modulated data signal and carrier.

It is worthwhile to note that terms “include”, “comprise” or any other variant is intended to cover non-exclusive inclusion, so that processes, methods, commodities or devices that include a series of elements include not only those elements but also other elements that are not explicitly listed, or elements inherent in such processes, methods, commodities or devices. An element described by “includes a . . . ” further includes, without more constraints, another identical element in the process, method, product, or device that includes the element.

The present specification can be described in the general context of computer executable instructions executed by a computer, for example, a program module. Generally, the program module includes a routine, a program, an object, a component, a data structure, etc. executing a specific task or implementing a specific abstract data type. The present specification can also be practiced in distributed computing environments. In the distributed computing environments, tasks are performed by remote processing devices connected through a communications network. In a distributed computing environment, the program module can be located in both local and remote computer storage media including storage devices.

It is worthwhile to note that the implementations of the present specification are described in a progressive way. For same or similar parts of the implementations, mutual references can be made to the implementations. Each implementation focuses on a difference from the other implementations. Particularly, a system implementation is basically similar to a method implementation, and therefore is described briefly. For related parts, references can be made to related descriptions in the method implementation.

The described descriptions are merely examples of the present specification and are not intended to limit the present application. For a person skilled in the art, the present application may be subject to various modifications and variations. Any modification, equivalent replacement or improvement made within spirit and principles of the present application shall be included in claims of the present application.

1. A computer-implemented method for obtaining a bank card signing information element, comprising:
obtaining, by a data processing device, a bank card signing request that binds a to-be-signed bank card of a first user with a payment institution account;
determining, by the data processing device, that the bank card signing request is from an application or device authorized by the first user, wherein the application or device authorized by the first user comprises a device that the first user is operating on, an application installed on the device that the first user is operating on, or an application that the first user has successfully logged in;
obtaining, by the data processing device, a bank card token corresponding to the to-be-signed bank card based on parsing the bank card signing request, wherein the bank card token is generated by a card issuing bank that issues the to-be-signed bank card to the first user corresponding to the to the to-be-signed bank card;
identifying, by the data processing device, the card issuing bank based on the bank card token;
initiating, by the data processing device, an access request to the card issuing bank requesting a signing information element corresponding to the first user's to-be-signed bank card, wherein the signing information element comprises card holder information of the first user and bank card information of the to-be-signed bank card;
receiving, by the data processing device, the signing information element from the card issuing bank; and
signing, by the data processing device using the signing information element, the to-be-signed bank card for the first user in making a payment using the to-be-signed bank card via the payment institution account.

2. The computer-implemented method according to claim 1, wherein obtaining a bank card signing request comprises receiving the bank card signing request based on an operation of the first user at an invocation end of a bank application.

3. The computer-implemented method according to claim 1, wherein obtaining a bank card signing request comprises collecting the bank card signing request based on a code scanning operation of the first user on a bank counter.

4. The computer-implemented method according to claim 1, further comprising:
invoking and entering an application that parses the bank card signing request based on the bank card signing request.

5. The computer-implemented method according to claim 4, wherein invoking and entering an application that parses the bank card signing request based on the bank card signing request comprises: invoking the application based on a schema with a landing page, wherein the schema specifies an application opening link with a fixed application identifier.

6. The computer-implemented method according to claim 1, wherein an application of a payment institution that requires bank card signing parses the bank card signing request and initiates the access request to the card issuing bank to obtain the signing information element.

7. The computer-implemented method according to claim 1, wherein the application that the first user has successfully logged in obtains the bank card signing request, parses the bank card signing request, and initiates the access request to the card issuing bank to obtain the signing information element.

8. A non-transitory, computer-readable medium storing one or more instructions executable by a computer system to perform one or more operations comprising:
obtaining a bank card signing request that binds a to-be-signed bank card of a first user with a payment institution account;
determining that the bank card signing request is from an application or device authorized by the first user, wherein the application or device authorized by the first user comprises a device that the first user is operating on, an application installed on the device that the first user is operating on, or an application that the first user has successfully logged in;
obtaining a bank card token corresponding to the to-be-signed bank card based on parsing the bank card signing request, wherein the bank card token is generated by a card issuing bank that issues the to-be-signed bank card to the first user corresponding to the to the to-be-signed bank card;
identifying the card issuing bank based on the bank card token;
initiating an access request to the card issuing bank requesting a signing information element corresponding to the first user's to-be-signed bank card, wherein the signing information element comprises card holder information of the first user and bank card information of the to-be-signed bank card;
receiving the signing information element from the card issuing bank; and
signing, using the signing information element, the to-be-signed bank card for the first user in making a payment using the to-be-signed bank card via the payment institution account.

9. The non-transitory, computer-readable medium according to claim 8, wherein obtaining a bank card signing request comprises receiving the bank card signing request based on an operation of the first user at an invocation end of a bank application.

10. The non-transitory, computer-readable medium according to claim 8, wherein obtaining a bank card signing request comprises collecting the bank card signing request based on a code scanning operation of the first user on a bank counter.

11. The non-transitory, computer-readable medium according to claim 8, wherein the one or more operations further comprise:
invoking and entering an application that parses the bank card signing request based on the bank card signing request.

12. The non-transitory, computer-readable medium according to claim 11, wherein invoking and entering an application that parses the bank card signing request based on the bank card signing request comprises: invoking the application based on a schema with a landing page, wherein the schema specifies an application opening link with a fixed application identifier.

13. The non-transitory, computer-readable medium according to claim 8, wherein an application of a payment institution that requires bank card signing parses the bank card signing request and initiates the access request to the card issuing bank to obtain the signing information element.

14. The non-transitory, computer-readable medium according to claim 8, wherein the application that the first user has successfully logged in obtains the bank card signing request, parses the bank card signing request, and initiates the access request to the card issuing bank to obtain the signing information element.

15. A computer-implemented system, comprising:
one or more computers; and
one or more computer memory devices interoperably coupled with the one or more computers and having tangible, non-transitory, machine-readable media storing one or more instructions that, when executed by the one or more computers, perform one or more operations comprising:
obtaining a bank card signing request that binds a to-be-signed bank card of a first user with a payment institution account;
determining that the bank card signing request is from an application or device authorized by the first user, wherein the application or device authorized by the first user comprises a device that the first user is operating on, an application installed on the device that the first user is operating on, or an application that the first user has successfully logged in;
obtaining a bank card token corresponding to the to-be-signed bank card based on parsing the bank card signing request, wherein the bank card token is generated by a card issuing bank that issues the to-be-signed bank card to the first user corresponding to the to the to-be-signed bank card;
identifying the card issuing bank based on the bank card token;
initiating an access request to the card issuing bank requesting a signing information element corresponding to the first user's to-be-signed bank card, wherein the signing information element comprises card holder information of the first user and bank card information of the to-be-signed bank card;
receiving the signing information element from the card issuing bank; and
signing, using the signing information element, the to-be-signed bank card for the first user in making a payment using the to-be-signed bank card via the payment institution account.

16. The computer-implemented system according to claim 15, wherein obtaining a bank card signing request comprises receiving the bank card signing request based on an operation of the first user at an invocation end of a bank application.

17. The computer-implemented system according to claim 15, wherein obtaining a bank card signing request comprises collecting the bank card signing request based on a code scanning operation of the first user on a bank counter.

18. The computer-implemented system according to claim 15, wherein the one or more operations further comprise:
invoking and entering an application that parses the bank card signing request based on the bank card signing request, wherein invoking and entering an application that parses the bank card signing request based on the bank card signing request comprises: invoking the application based on a schema with a landing page, wherein the schema specifies an application opening link with a fixed application identifier.

19. The computer-implemented system according to claim 15, wherein an application of a payment institution that requires bank card signing parses the bank card signing request and initiates the access request to the card issuing bank to obtain the signing information element.

20. The computer-implemented system according to claim 15, wherein the application that the first user has successfully logged in obtains the bank card signing request, parses the bank card signing request, and initiates the access request to the card issuing bank to obtain the signing information element.
